(19) United States
(12) Patent Application Publication
(10) Pub. No.: US 2012/0299304 A1
(43) Pub. Date: Nov. 29, 2012

(54) Apparatus for Generating Electrical Energy

(76) Inventor: Abdulreidha Al-Saffar, Mubarak Alkabeer (KW)

(21) Appl. No.: 13/116,448

(22) Filed: May 26, 2011

(51) Int. Cl. F03B 13/08; F03B 17/04

(52) U.S. Cl. 290/54; 415/916

(57) ABSTRACT

An apparatus for generating electrical energy includes a base level and an elevated platform with a water tank disposed on the elevated platform. A source of water disposed on the base level while a plurality of relatively small pumps and conduits connect the source of water to each of the pumps and each of the pumps to the water tank on the platform. The source of electrical energy is provided for energizing the pumps for pumping the water upwardly from the source of water into the water tank. In addition, the apparatus includes a plurality of structural supports disposed on at least three different levels intermediate at the base level and the elevated platform with a waterwheel including a plurality of radially disposed and laterally extending plate-like fans is disposed one below another on the structural supports. Finally, an electrical generator is operatively connected to each of the waterwheels.

### FIELD OF THE INVENTION

This invention relates to an apparatus for generating electrical energy for a plant or community and more particularly to an apparatus for generating electricity in response to water falling downwardly through a plurality of waterwheels.

### BACKGROUND FOR THE INVENTION

The use of hydroelectric power is well known and has been in use for many years. Such systems have been and continue to be use to generate power with little or no pollution economically. For example, a United States Patent of Liou, U.S. Pat. No. 5,905,312 discloses a system for generating electricity by gravity. The system includes a plurality of tanks mounted on a circulating device. When the tanks receive the working medium descending from a higher place by gravity, the circulating device is driven to circulate along a guiding device in order to drive a working shaft of a generator for generating electricity. A transmission mechanism is added between the circulating device and the working shaft to increase the rotational speed of a working shaft.

A more recent approach to a gravity electrical generating system is disclosed in a U.S. Patent of Cieslak, Jr., U.S. Pat. No. 6,445,078. As disclosed therein, a system for gravity generation of electricity includes upper and lower water reservoirs with a conduit between the reservoirs and a pump to continuously pump water from the lower reservoir to the upper reservoir. A number of water containers are positioned side-by-side and mounted for up and down travel between the upper and lower reservoirs. When the containers have obtained their upper most position at the upper reservoir, they are engaged by a limit switch mechanisms to fill the containers with water from the upper reservoir. Upon being full, the containers travel by gravity to their lower most position to the lower reservoir where an additional limit switch mechanism is employed to drain the containers into the bottom reservoir. As the containers travel downwardly, they engage and drive an electrical generator for generating large quantities of electricity. Once the containers are at their lower most position and have been fully drained they are driven back up to the upper reservoir to refill by independent gear motors.

Finally, an enhanced pumped storage power system is disclosed in a U.S. Pat. No. 7,003,955 of Davis. As disclosed a system is a regenerative power system that utilizes the gravitational forces of downward movement of large quantities of water to convert the same to electrical energy. In the preferred mode of implementation, the system utilizes a man-made lake at a first level of elevation. The lake need only be approximately 20 to 30 feet in elevation. The lake which may exceed 100 acres in size may be elevated above and adjacent a natural body of water, such as sea water at a coast line. As such, sandy terrain associated with the region facilitates initial construction of the system. An underground generator is utilized for the power conversion in pumping of the water back to the upper reservoir during times of low energy demand. Importantly, the system may he utilized to provide significant levels of power to serve relatively large geographic areas during times of peak energy demand when other sources of power are more expensive and subject to power outages. Finally, it should be noted that the components of the system are esthetically pleasing in nature, allowing the system to be effectively utilized in a residential area.

Notwithstanding the above it is presently believed that there is a need and a potential commercial market for an apparatus for generating electrical energy in accordance with the present invention. There should be a need for such systems because they are relatively free from pollution, economical, and reliable. In addition, such systems are also believed to be capable of construction at a competitive cost and relatively free from maintenance.

### BRIEF SUMMARY OF THE INVENTION

In essence an apparatus for generating electrical energy for a small plant or community includes a base level and an elevated platform disposed above said base level and a water tank disposed on the elevated platform. The apparatus also includes a source of water disposed in the base level and a plurality of relatively small pumps and conduits for conducting water from the source of water to each of the pumps and from each of the pumps to the water tank on the platform. In addition, means for energizing the pumps is provided for pumping water upwardly from the source of water to the water tank.

In addition to the above, a plurality of structural supports is disposed at three different levels intermediate of the base level and the elevated platform. A waterwheel including a plurality of radially disposed and laterally extending plate-like blades are disposed, one below another, on the structural supports and an electrical generator is operatively connected to each of the waterwheels. Further, a plurality of ducts connect the water tank sequentially with a first, a second and a third waterwheel as the water from the water tank flows downwardly through the ducts and through the waterwheels. The waterwheels turn the generators to produce electrical energy for the plant or community and wherein the water flows downwardly through the ducts and through the waterwheels.

Finally, an electrical control means combines the electrical energy from each of the generators.

The invention will now be described in connection with the accompanying drawings wherein like reference numerals have been used to indicate like parts.

### DESCRIPTION OF THE DRAWINGS

FIG. 1 is a schematic illustration of an apparatus for generating electrical energy in accordance with a first embodiment of the invention;

FIG. 2 is a schematic illustration of the system shown in FIG. 1 but rotated by 90°;

FIG. 3 is a perspective view of a waterwheel and duct work for use in the present invention;

FIG. 4 is a schematic illustration of the duct work bypass and waterwheel as used in the present invention;

FIG. 5 is a schematic illustration of the waterwheel and electrical generator as used in the present invention

### DESCRIPTION OF THE PREFERRED EMBODIMENTS OF THE INVENTION

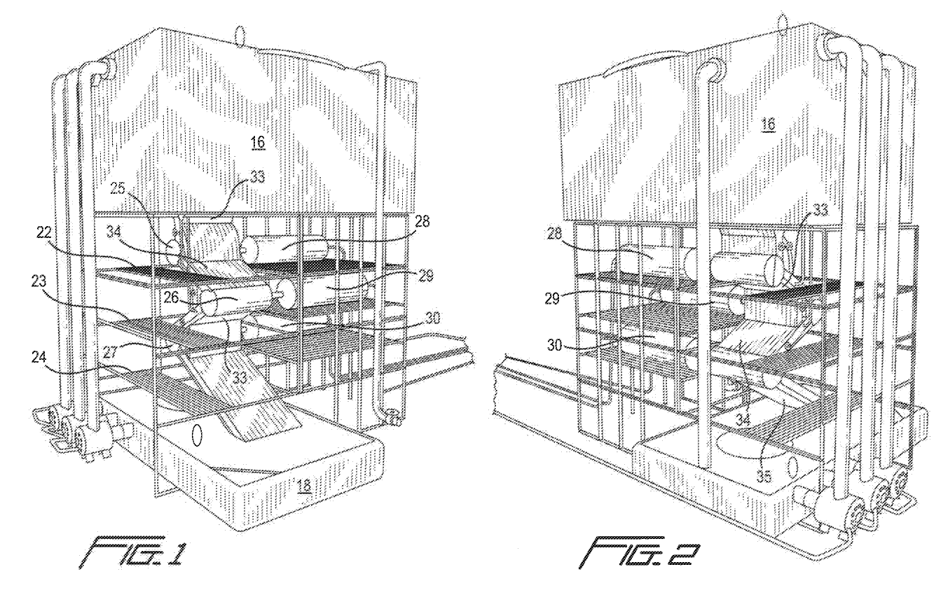

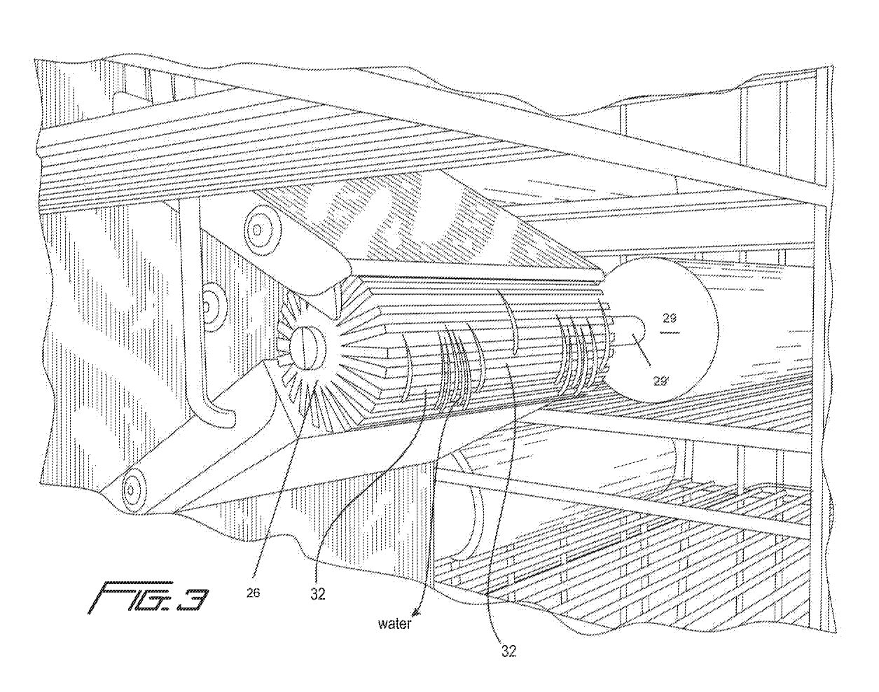

As shown in FIGS. 1 and 2, an apparatus 10 for generating electrical energy for a plant or small community includes a base level 12 and an elevated platform 14 positioned above the base level 12 and a large water tank 16 is disposed on the elevated platform 14. In a preferred embodiment of the invention a second water tank 18 is provided or positioned on the base level 12 and used as a source of water.

A plurality of relatively small pumps 20 and conduits 22 connect each of the pumps 20 to the second water tank 18 and each of the pumps 20 to the first water tank 16 on the elevated platform 14. The pumps 20 are each connected to a source of electrical energy in order to pump water from the second water tank 18 to the first water tank 16.

An important feature of the present invention resides in a plurality of structural supports 22, 23 and 24 that are positioned below the elevated platform 14 and above the base level and a plurality of waterwheels 25, 26, and 27 with one of the waterwheels disposed on each of the structural supports 22, 23 and 24. In addition, electrical generators 28, 29 and 30 with one of the generators operatively connected to one of the waterwheels on each of the structural supports.

Each of the waterwheels 25, 26 and 27 include a plurality of radially disposed and laterally extending plate-like blades 32. Each of the waterwheels are disposed one below another on each of the structural supports 22, 23 and 24. A plurality of ducts 33, 34 and 35 connect the waterwheels and channel the downward flow of water from a first waterwheel, to the second waterwheel and onto a third waterwheel before being returned to the second tank.

In the preferred embodiment of the invention the ductwork i.e. ducts 33, 34 and 35 each include a bypass 36, 37 and 38 with valves to bypass one waterwheel so that maintenance can be performed on the one waterwheel without shutting the entire facility down.

The apparatus 10 also includes a control means or circuit for combining the electrical energy from each of the generators.

As shown in FIGS. 1 and 2, two identical plants are provided in a side-by-side arrangement to produce enough electrical energy to operate a plant or serve a small community.

FIG. 2 is a side schematic view of the apparatus for generating electrical energy shown in FIG. 1. It is estimated that as water flows through the apparatus there will be about a 2% loss of water due to evaporation and that additional water can be added to one or more tanks from a water truck or other source. A float and control valve may also be used with a relatively small pump to add water as needed.

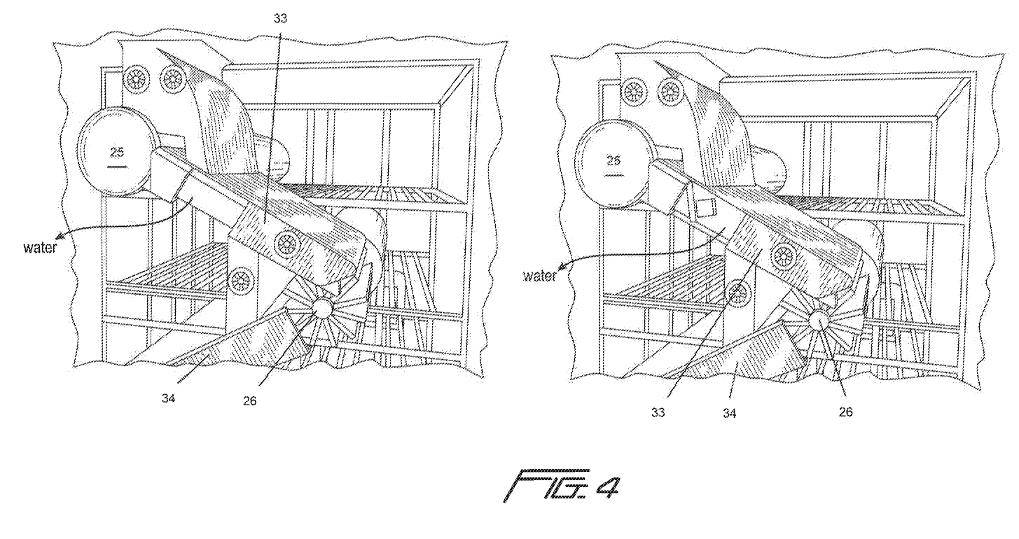

As illustrated in FIG. 3, a water wheel 26 is disposed between an upper duct 33 and a lower duct 34 for directing downwardly cascading water to and from water wheel 26 and on toward an additional water wheel 27. It is recognized that a gasoline or diesel motor may be used to pump water from a lower tank to an upper tank. As shown, the water wheel 26 is connected to an electrical generator 29 by a shaft 29′ and turns the generator 29 to generate electrical energy.

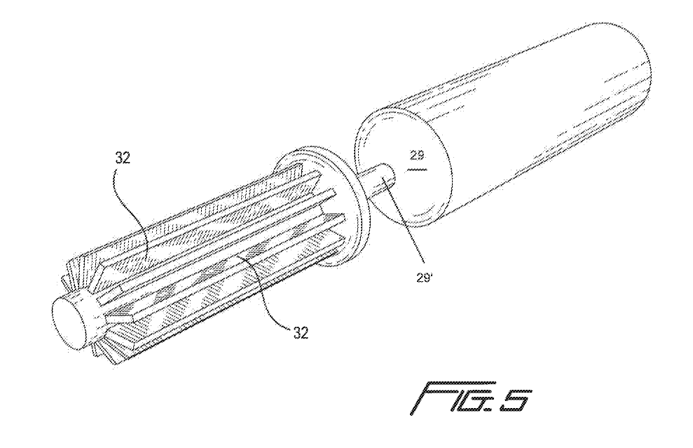

Duct work or ducts 33 and 34 for directing downwardly cascading water from an upper water wheel to a lower water wheel are shown in more detail in FIGS. 4 and 5. The ducts and water wheels are supported on a stainless steel H-shaped structure and supported on various levels. Finally, each of the water wheels include a plurality of blades 32 and are connected to an electrical generator 29 as shown in FIG. 5 by a the shaft 29′.

As shown, the generators 28, 29 and 30 are rotated by wheels 25, 26, and 27 respectively. As illustrated an example using three turbines is shown to clarify the idea while it has been recognized that it is possible to put any number of the electric turbines according to the need and as per the size of the city, village or plant. It is also recognized that a large and durable platform needs to be built for the desired number of turbines and for a relatively large tank as illustrated in FIG. 1.

It is also recognized that after installing the turbines on the steel structure the turbines are strongly fixed in place and a cable runs from the turbine to a power station to distribute the electricity to any area. A portion of the power can also be used to power the water pumps for the operation of the station. The large tank used in an upper portion of the structure should be water and heat proof to prevent water leakage. In addition, a gate is put on the water tank and should be tight to prevent water leakage. A safety valve is also put on the tank and will in the case of filling the tank with water allow air from inside to be removed to avoid damage of the tank.

Further, a large basin is preferably built under the platform and should also avoid water leakage or evaporation. For that reason it is preferably covered with fiberglass for avoiding water leakage. In the preferred embodiment a safety valve is provided on the ground tank to keep the pressure inside the tank within a reasonable limit.

The blades shown in FIG. 5 should be covered to avoid any leakage of water while water is passing the blades. Accordingly, there should be a duct between the upper duct and lower duct for directing water passing through the water wheel into a lower duct where it will be delivered towards another water wheel.

It is also recognized in the case of any damage to any turbine or blade a connection between each duct on the top of duct to the bottom, there is a valve to close the damage turbine and the water is transferred to either the following duct or another part of the system during maintenance and replacement.

While the invention has been disclosed in connection with its preferred embodiments it should be recognized that changes and modifications may he made therein without departing from the scope of the claims.

What is claimed:

1. An apparatus for generating electrical energy to a plant or community, said apparatus comprising:
a base level and an elevated platform disposed above said base level and a water tank disposed on said elevated platform;
a source of water disposed on said base level and a plurality of relatively small pumps and conduits for connecting said source of water to each of said pumps and each of said pumps to said water tank and means for energizing said pumps for pumping water upwardly from said source of water and into said water tank;
a plurality of structural supports disposed at three different levels intermediate of said base level and said elevated platform and a waterwheel assembly including a plurality of radially disposed and laterally extending plate-like fans disposed one below another on said structural supports; and
an electrical generator operatively connected to each of said waterwheels;
a plurality of ducts connecting said water tank sequentially with a first, a second and a third waterwheel as the water from said water tank flows downwardly through said first, said second and said third ducts to turn said generators to produce electrical energy for the plant or community and wherein the water flows downwardly through said ducts and said waterwheels; and
an electrical control means for combining the electrical energy from each of said generators and conducting said energy to a grid.

2. An apparatus for generating electrical energy to a plant or community according to claim 1 which includes bypass means for channeling falling water past a waterwheel for repairs and maintenance of the bypass waterwheel.

3. An apparatus for generating electrical energy to a plant or community according to claim 2 in which said water tank is sealed, but includes a one-way valve to allow air to escape from said tank as the tank is filled with water.

4. An apparatus for generating electrical energy to a plant or community according to claim 3 in which said source of water is a closed tank that receives water that has passed through said waterwheels.

5. An apparatus for generating electrical energy to a plant or community according to claim 4 which includes a lower tank at said base level and a safety valve in said lower tank.

6. An apparatus for generating electrical energy to a plant or community, said apparatus consisting of:
a base level and an elevated platform disposed above said base level and a water tank disposed on said elevated platform;
a second water tank to be used as a source of water disposed on said base level and a plurality of relatively small pumps and conduits for connecting said second water tank to each of said pumps and each of said pumps to said water tank on said elevated platform, and means for energizing said pumps for pumping water upwardly from said base level water tank and into said first water tank on said elevated platform;
a plurality of structural supports disposed at three different levels intermediate at said base level and said elevated platform and a waterwheel including a plurality of radially disposed and lateral extending plate-like blades and wherein each of said water wheels are disposed one below another on said structural supports, and an electrical generator operatively connected to each of said waterwheels;
a plurality of ducts connecting said waterwheels sequentially with a first, a second and a third waterwheel as the water from said water tank flows downwardly through said ducts and said waterwheels to turn said generators to produce electrical energy for the plant or community and wherein the water flows downwardly through said ducts and said waterwheels;
an electrical control means for combining electrical energy for use by said plant or community; and
bypass means for channeling falling water past a waterwheel for repairs and maintenance of the bypass waterwheel.
